(19) United States
(12) Patent Application Publication
(10) Pub. No.: US 2026/0158380 A1
(43) Pub. Date: Jun. 11, 2026

(54) TECHNIQUES FOR CLIENT-SIDE UPSCALING OF VIDEO GAMES

(71) Applicant: NETFLIX, INC., Los Gatos, CA (US)

(72) Inventors: William Francis CORK, Rohnert Park, CA (US); Thomas ENGEL, Fairfax, CA (US); Julian Alexander EGGEBRECHT, San Rafael, CA (US)

(21) Appl. No.: 18/974,150

(22) Filed: Dec. 9, 2024

(51) Int. Cl. A63F 13/52; G06T 3/4046

(52) U.S. Cl. CPC A63F 13/52; G06T 3/4046; G06T 2200/24

(57) ABSTRACT

In various embodiments, the disclosed techniques allow for client-side upscaling of streamed video games. For example, a server executes a video game and renders frames thereof using a graphics processing unit (GPU) of the server. The frames are rendered at a low resolution. The server extracts layers of information needed to upscale the rendered frames from one or more buffers in the GPU. The layers of information can include color data, depth data, motion vector data, state data, and one or more sharpening factors. The server encodes the rendered frames and the layers of information. The server streams, over a network, the encoded frame data and the encoded layers of information to a user device. The user device can decode and upscale the frame using the layers of information, and then display the upscaled frame. The upscaled frame is of a higher resolution than the rendered frame.

### BACKGROUND

### Field of the Various Embodiments

The various embodiments relate generally to computer science and video game streaming and, more specifically, to techniques for client-side upscaling of video games.

### Description of the Related Art

Video games often require powerful computing devices to properly render the three-dimensional (3D) objects and environments within those games. Rendering is the process of turning data and instructions of a video game into the visuals that appear on a screen. Rendering can be very computationally expensive for even the most state-of-the-art computing devices.

Cloud gaming, or gaming on demand, allows users to play video games remotely without needing to own powerful computing devices that can run the video games. Cloud gaming functions by streaming a video game over the Internet from a server device of a cloud gaming provider to a user device. The server device runs a video game, which includes rendering the 3D objects and environments of the game to images frames, and then streams those frames (or compressed versions thereof) for playback by the user device. By doing so, the computational resource requirements of the user device can be drastically reduced. However, the resource requirements are transferred to the server device, which can quickly add up when a large number of video games are being streamed to different client devices.

One approach for reducing the computational resources needed to render video games on the server device is to render the frames of a video game at a low resolution and/or to render the visuals of the video game at a lower level of detail. However, doing so can significantly reduce the overall quality of the rendered frames of the video game.

Another approach for reducing the computational resources needed to render video games on the server device is to render frames at a low resolution, upscale those frames to a higher resolution, and then transmit the upscaled frames to the user device. Upscaling is the process of increasing the size of an image while maintaining or improving the clarity and detail. Upscaling frames that are rendered at a lower resolution to a higher resolution can require less computational resources than rendering the frames at the higher resolution in the first place.

Using the server device to upscale the rendered frames of a video game has various drawbacks. Even though such upscaling can require less computational resources than rendering the frames at a higher resolution, the computational resources required to upscale the frames can still be significant at scale when the server device streams many games to different user devices. In addition, the network bandwidth needed to transmit the upscaled frames can be significant.

As the foregoing illustrates, what is needed in the art are more effective techniques for streaming video games.

### SUMMARY

One embodiment of the present invention sets forth a computer-implemented method for client-side upscaling of video games. The method includes rendering, via a graphics processing unit (GPU) and at a first resolution, a frame associated with a video game. The method also includes extracting one or more layers of information from one or more buffers of the GPU. The method further includes encoding the frame to generate an encoded frame and the one or more layers of information to generate one or more encoded layers of information. In addition, the method includes transmitting, to a user device, the encoded frame and the one or more encoded layers of information, where the user device upscales a decoding of the encoded frame to a second resolution based on a decoding of the one or more encoded layers of information.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, the upscaling of the rendered frames of a video game is performed on a user device rather than a server device. By utilizing a GPU of the user device to perform the upscaling, computational resources of the server device and network bandwidth can be conserved. In turn, the server device can be used to execute and stream video games to a larger number of user devices. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of a server of FIG. 1, according to various embodiments;

FIG. 3 is a more detailed illustration of the GPU of FIG. 2, according to various embodiments;

FIG. 4 is a more detailed illustration of a user device of FIG. 1, according to various embodiments;

FIG. 5 is a flow diagram of method steps for streaming video games to a user device, according to various embodiments; and

FIG. 6 is a flow diagram of method steps for client-side upscaling of a streamed video game, according to various embodiments.

### DETAILED DESCRIPTION

In the following description, numerous specific details are set forth to provide a more thorough understanding of the various embodiments. However, it will be apparent to one skilled in the art that the inventive concepts can be practiced without one or more of these specific details.

As described, using a server device to upscale the rendered frames of a video game has various drawbacks. Even though such upscaling can require less computational resources than rendering the frames at a higher resolution, the computational resources required to upscale the frames can still be significant at scale when the server device streams many games to different user devices. In addition, the network bandwidth needed to transmit the upscaled frames can be significant.

The disclosed techniques allow for client-side upscaling of streamed video games. As used herein, a video game refers to any application that provides an interactive three-dimensional (3D) space, such as an electronic game, a metaverse, or the like. In some embodiments, a server executes a video game and renders frames thereof using a graphics processing unit (GPU) of the server. The frames are rendered at a low resolution (e.g., below 1080p). The server extracts layers of information needed to upscale the rendered frames from one or more buffers in the GPU of the server. The layers of information can include color data, depth data, motion vector data, state data, and one or more sharpening factors. The layers of information can also include a reactive mask and a transparency and composition mask. The server encodes the rendered frames and the layers of information. The server streams, over a network, the encoded frame data and the encoded layers of information to a user device. A separate channel can be used to stream each of the encoded frame data and each layer of information in the encoded layers of information. Once received by the user device, the user device can decode and upscale the frame using the layers of information, and then display the upscaled frame. The upscaled frame is of a higher resolution than the rendered frame. In some embodiments, another layer that includes data (e.g., assets) associated with a user interface can also be streamed via another channel to the user device, after which the user device can use the streamed layer of data to render the user interface at a native resolution of the user device.

At least one technical advantage of the disclosed techniques relative to the prior art is that, with the disclosed techniques, the upscaling of the rendered frames of a video game is performed on a user device rather than a server device. By utilizing a GPU of the user device to perform the upscaling, computational resources of the server device and network bandwidth can be conserved. In turn, the server device can be used to execute and stream video games to a larger number of user devices.

### System Overview

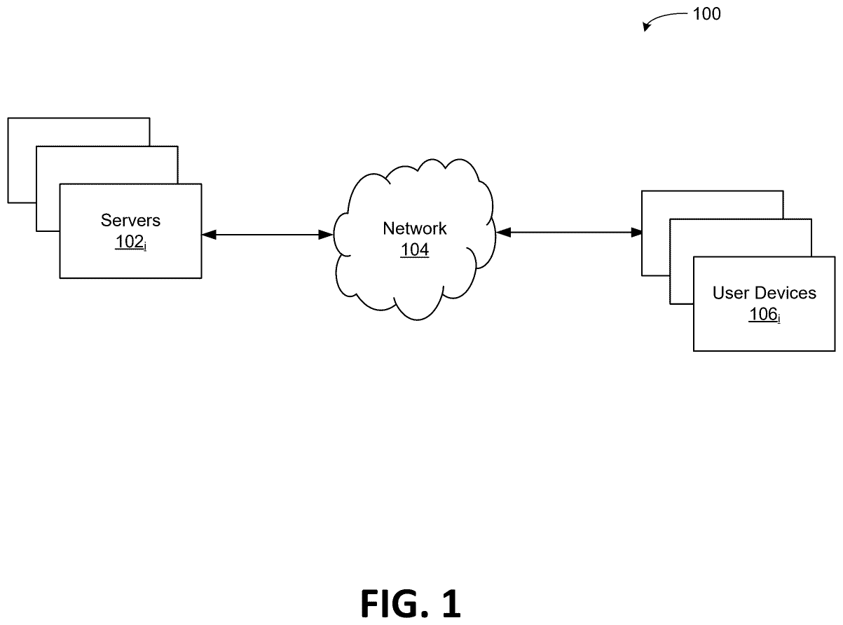

FIG. 1 illustrates a block diagram of a computer-based system 100 configured to implement one or more aspects of the various embodiments. As shown, system 100 includes, without limitation, one or more servers 102ᵢ (referred to herein collectively as servers 102 and individually as a server 102), a network 104, and one or more user devices 106ᵢ (referred to herein collectively as devices 106 and individually as a device 106).

System 100 is shown herein for illustrative purposes only, and variations and modifications are possible without departing from the scope of the present disclosure. For example, the number and types of servers and/or user devices can be modified as desired. Further, the connection topology between the various units in FIG. 1 can be modified as desired. In some embodiments, any combination of the servers and/or user devices can be included in and/or replaced with any type of virtual computing system, distributed computing system, and/or cloud computing environment, such as a public, private, or a hybrid cloud system.

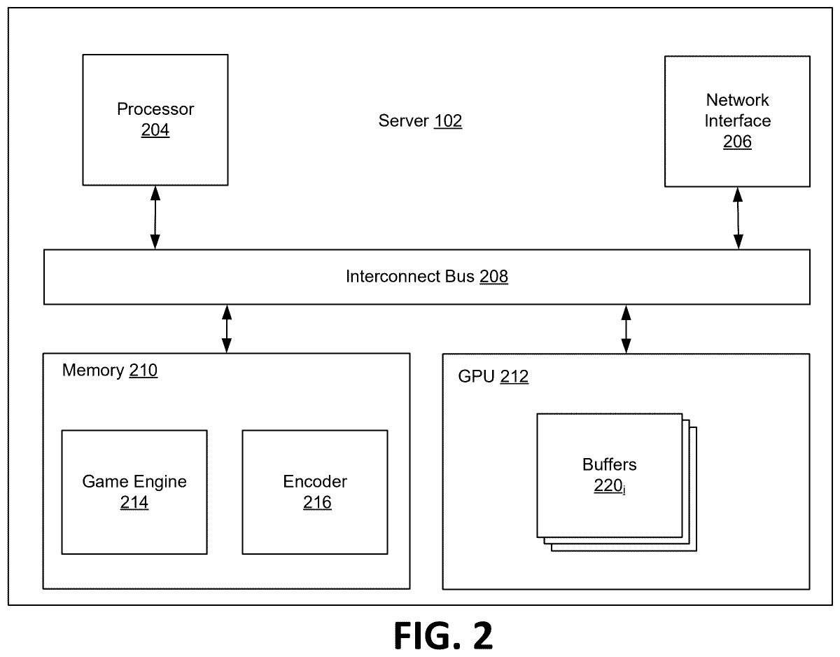

Servers 102 are computing devices that can execute program instructions for one or more video games, render frames of the one or more video games, and deliver the rendered frames, as well as layers of information needed to upscale the frames to a higher resolution, to user devices 106 via network 104. As described in greater detail below in conjunction with FIG. 2, a server 102 can include memory, at least one processor, and at least one graphics processor. For example, a server 102 can include memory (not shown) to store program instructions of the video game and an encoder (not shown) to encode frames of the video game. Additionally, server 102 can include a central processing unit (CPU) (not shown) for executing the program instructions of the video game. The server 102 can also include a GPU (not shown) for performing advanced graphical operations, such as graphics rendering, texture mapping, shader processing, and frame-rate management.

Network 104 can be any technically feasible network that is configured to allow servers 102 to communicate with user devices 106. For example, network 104 can be a wide area network (WAN) such as the Internet, a local area network (LAN), a Wi-Fi network, or a combination thereof. Network 104 is configured to allow communication via an Ethernet Network, a Bluetooth® network, a wireless network, or any other technically feasible network for communicating frames of video games and related layers of information.

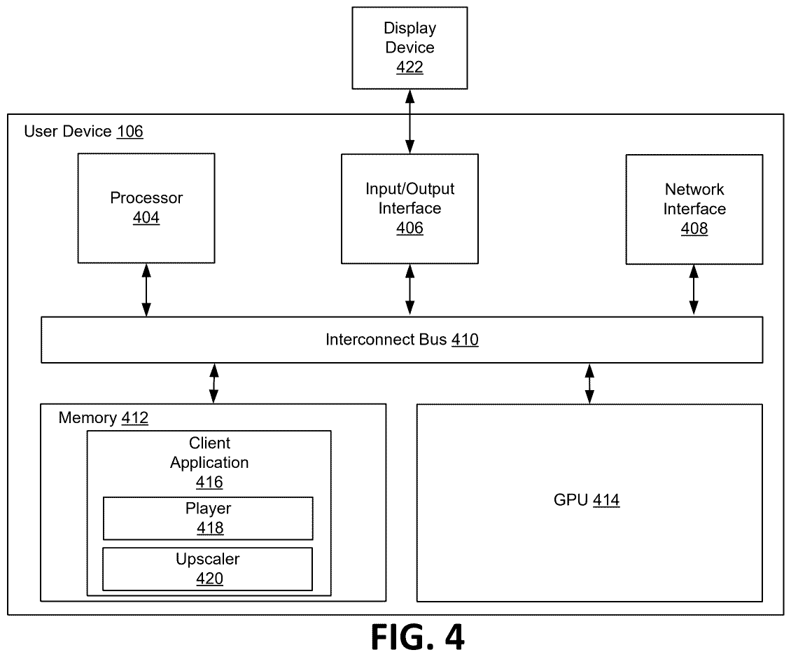

User devices 106 can include computer systems, set top boxes, mobile devices, smartphones, tablets, console and handheld video game systems, digital video recorders (DVRs), DVD players, connected digital TVs, dedicated media streaming devices (e.g., the Roku® set-top box), and/or any other technically feasible computing device that has network connectivity and is capable of upscaling and displaying frames of a video game to a user. In operation, user device 106 is configured to communicate with servers 102 via the network 104 to receive graphical data, such as frames of a video game, and upscale the graphical data to a higher resolution for presentation on a display device (not shown). The display device can be part of user device 102 or distinct from user device 102. As described in greater detail below in conjunction with FIG. 4, in some embodiments, a user device 106 can include at least a processor, a GPU, memory, an input/output interface, and a display device. For example, the memory of a user device 106 can include one or more client applications. A client application running on a user device 106 can connect to and communicate with a server 102 or other network components to access, consume and manipulate content or engage in various digital activities, including streaming video games.

FIG. 2 is a more detailed illustration of a server 102 according to various embodiments. As described above, a server 102 is a computing device that can execute program instructions for one or more video games, render frames of the one or more video games, and deliver the rendered frames, as well as layers of information needed to upscale the frames to a higher resolution, to one or more user devices 106 via network 104. As shown, server 102 includes, without limitation, a processor 204, a network interface 206, an interconnect bus 208, a memory 210, and a GPU 212. Memory 210 includes a game engine 214 and an encoder 216. GPU 212 includes one or more buffers 220ᵢ (referred to herein collectively as buffers 220 and individually as a buffer 220).

Processor 204 is configured to read and write data from memory 210. Processor 204 is configured to retrieve and execute programming instructions, such as instructions for a game engine 214 and encoder 216, stored in memory 210. Similarly, processor 204 is configured to store video game application data (e.g., software libraries) and retrieve video game application data from memory 210. Processor 204 can be any suitable processor, such as a CPU, an application-specific integrated circuit (ASIC), a field programmable gate array (FPGA), a digital signal processor (DSP), and/or any other type of processing unit, or a combination of processing units. In general, processor 204 can be any technically feasible hardware unit capable of processing data and/or executing software applications. Interconnect 208 is configured to facilitate transmission of data, such as programming instructions and application data, between processor 204 and network interface 206, memory 210, and GPU 212.

Network interface 206 is configured to transmit and receive audio content from a network (not shown). In some embodiments, network interface 206 is configured to communicate using an Ethernet Network, a Bluetooth® network, a wireless network, or any other technically feasible network for communicating video game data. Network interface 206 communicates with processor 204, memory 210, and GPU 212 via interconnect bus 208.

Interconnect bus 208 is configured to facilitate transmission of data, such as programming instructions, application data, audio and/or video data, and other data, between processor 204, network interface 206, memory 210, GPU 212 and any other components of server 102. Other aspects of server 102 that are not shown can also communicate with each other aspect of server 102 using interconnect bus 208.

Memory 210 can include a random-access memory (RAM) module, a flash memory unit, or any other type of memory unit or combination thereof. In various embodiments, memory 210 includes non-volatile memory, such as optical drives, magnetic drives, flash drives, or other storage. In some embodiments, separate data stores, such as an external data store included in a network (“cloud storage”) (not shown) can supplement the memory 210. Game engine 214 and encoder 216 within memory 210 can be executed by processor 204 to implement the overall functionality of server 102 and, thus, to coordinate the operation of server 102 as a whole.

Game engine 214 is a specialized software and/or hardware framework designed to execute and run one or more video games. In some embodiments, game engine 214 can be included in a video game application (not shown). Game engine 214 includes a rendering engine that communicates with GPU 212 to render two-dimensional (2D) and/or 3D graphics of video games. Game engine 214 can also include a physics engine, a collision detection engine, a sound engine, one or more artificial intelligence models, one or more software libraries, and/or a memory management module to facilitate execution of video games and/or rendering of the frames of video games. Game engine 214 can provide platform abstraction allowing the same video game to run on various devices, such as servers 102 and/or user devices 106, with few, if any, changes to the source code of the video game.

Encoder 216 is specialized software and/or hardware designed to encode audio, video, and/or text data. Encoding is the process of converting raw digital content into a suitable format for storage, transmission, and/or display. Encoder 216 can process various types of content, such as audio, video, and/or text, by applying compression algorithms and encoding schemes to transform raw data content into one or more optimized, standardized formats. Encoder 216 can support multiple encoding standards and codecs to accommodate different content types and delivery platforms. For example, encoder 216 can perform video transcoding and generate different audio/video bit rates and segment encoded video to small chunks for distribution. In some embodiments, encoder 216 can be a YC_{B}C_{R} encoder, where Y represents the luma component of a pixel, C_{B} represents the blue-difference chroma component of a pixel, and C_{R} represents the red-difference chroma component of a pixel. YC_{B}C_{R} pixel formats are also sometimes referred to as YUV formats, where Y represents the luma component of a pixel, U represents the blue-difference chroma component of a pixel, and V represents the red-difference chroma component of a pixel. Encoder 216 can encode YC_{B}C_{R} pixel formats using any technically feasible encoding scheme, such as 4:4:4, 4:1:1, 4:2:2 and/or 4:2:0. Encoder 216 can encode YC_{B}C_{R} pixel formats in 10, 12, 16, or 24 bits per pixel depending on resources available. For example, by using lossless compression or utilizing available CPU resources, YC_{B}C_{R} pixel formats can be encoded into smaller bit representations without increasing the occurrence of data scrambling typical with smaller bit representations.

Encoder 216 is configured to receive rendered frames of video games and layers of information from GPU 212. Layers of information are stored in buffers 220 of GPU 212 and can be used to upscale a rendered frame of a video game. In some embodiments, the layers of information can include color data, depth data, motion vector data, state data, and one or more sharpening factors. In some embodiments, the layers of information can also include a reactive mask and a transparency and composition mask. Encoder 216 can read the layers of information from buffers 220 of GPU 212 in any technically feasible manner, such as via direct memory access (DMA). Similarly, rendered frames can be read from another buffer and transmitted to encoder 216. For example, in some embodiments, encoder 216 can encode one or more layers of information within the layers of information using 10 bits per pixel. In such cases, encoder 216 can scale down, for example, 32-bit floating-point values to the 10 bits using a lossless compression technique, and the reverse process can be performed during decoding. For example, depth values can be encoded as 10-bit integer values for the luminance values of pixels; the x and y components of motion vectors can be similarly encoded as red and green values, respectively, etc., of the pixels, thereby “hiding” the buffer 220 data in channels of video data. In some embodiments, encoder 216 also encodes the received frames from a native or raw format to a moving picture experts group 4 part 14 (MPEG-4 Part 14 or MP4) file format. The encoded frames and layers of information can be transmitted as different channels of a video stream (e.g., a H.264 stream or an AVI stream) and/or data stream (e.g., a webRTC stream) to a user device 106, which can then decode the same and use the decoded layers of information to upscale the encoded frames.

GPU 212 is a graphics processing unit that is a specialized electronic circuit configured to perform mathematical calculations at high speed to process graphics and video. In some embodiments, GPU 212 can be integrated into an integrated circuit, along with processor 204. In some embodiments, GPU 212 can be a discrete graphics processing unit or dedicated graphics processing unit, that is separate from processor 204. In some embodiments, GPU 212 is multiple graphics processing units working in tandem. GPU 212 is configured to perform the same operation on multiple data values simultaneously (e.g., parallel processing).

In some embodiments, GPU 212 is configured to generate frames of a video game and render the 2D and/or 3D graphics within the frames in combination with game engine 214. In some embodiments, GPU 212 is configured to start rendering a 2D user interface associated with a video game. Prior to completing the rendering of the user interface, the GPU 212 can be instructed to stop rendering the user interface such that a GPU on a user device can finish rendering the user interface in the native resolution of the user device. The assets (e.g., textures) and GPU command buffer information for rendering the user interface can be transmitted to a user device via network interface 206 in a similar manner as frames and/or layers of information. In some embodiments, the transmission of the user interface assets and command buffer information can be via a separate channel of a data stream.

Buffers, including buffers 220, are used to store data for use in operations of GPU 212. In some embodiments, each buffer 220 can be a first-in first-out (FIFO) buffer. A buffer 220 can be implemented, without limitation, as a single buffer, double buffer, circular buffer, array buffer, ring buffer, vertex buffer, constant buffer, or any other technically feasible type of buffer. In some embodiments, each buffer 220 includes a write pointer and read pointer (not shown) that reference locations in the memory of where one or more layers of information are stored. As described above, layers of information are stored in buffers 220 of GPU 212 and can be used to upscale a rendered frame of a video game. In some embodiments, the layers of information can include color data, depth data, motion vector data, state data, and one or more sharpening factors. In some embodiments, the layers of information can also include a reactive mask and a transparency and composition mask. Each layer of information can be stored in a separate buffer 220. Each layer of information can be extracted from buffer 220, encoded by encoder 216, and delivered to a user device 106 via network 104.

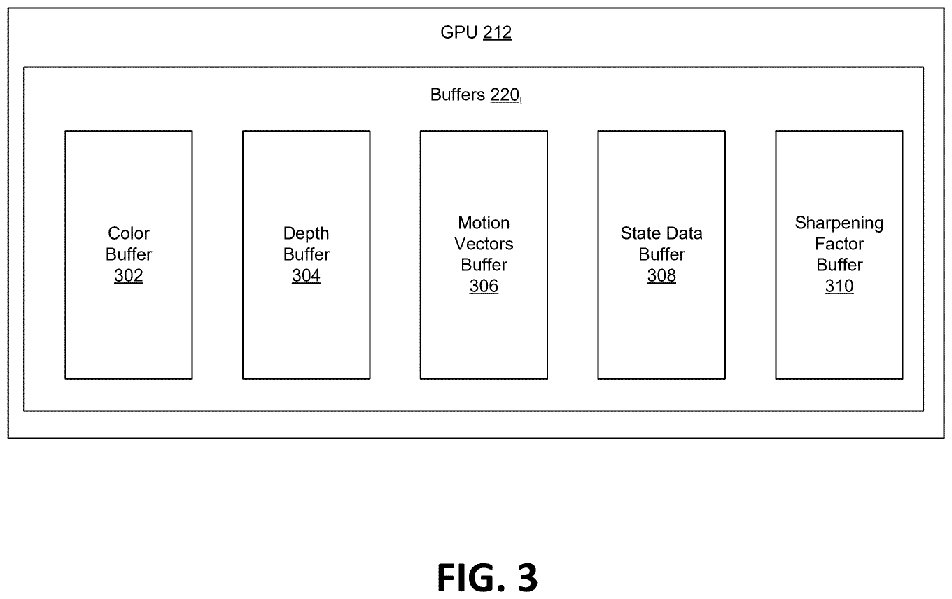

FIG. 3 is a more detailed illustration of GPU 212, according to various embodiments. As described above, GPU 212 is a graphics processing unit that is a specialized electronic circuit configured to perform mathematical calculations at high speed to process graphics and video. In some embodiments, GPU 212 can be integrated into an integrated circuit, along with processor 204. In some embodiments, GPU 212 can be a discrete graphics processing unit or dedicated graphics processing unit, that is separate from processor 204. In some embodiments, GPU 212 is multiple graphics processing units working in tandem. GPU 212 is configured to perform the same operation on multiple data values simultaneously (e.g., parallel processing).

As described, GPU 212 is configured to generate frames of a video game and render the 2D and/or 3D graphics within the frames in combination with game engine 214. GPU 212 also includes buffers 220, which include a color buffer 302, a depth buffer 304, a motion vectors buffer 306, a state data buffer 308, and a sharpening factor buffer 310. In some embodiments, buffers 220 also includes a reactive mask buffer (not shown) and a transparency and composition mask buffer (not shown). Buffers 220 can be configured to include any technically feasible buffer that can store layers of information that can be used to upscale a rendered video frame. In some embodiments, color buffer 302, depth buffer 304, motion vectors buffer 306, state data buffer 308, and sharpening factor buffer 310 can each be a first-in first-out (FIFO) buffer. Each of color buffer 302, depth buffer 304, motion vectors buffer 306, state data buffer 308, and sharpening factor buffer 310 can be implemented, without limitation, as a single buffer, double buffer, circular buffer, array buffer, ring buffer, vertex buffer, constant buffer, or any other technically feasible type of buffer. In some embodiments, each of color buffer 302, depth buffer 304, motion vectors buffer 306, state data buffer 308, and sharpening factor buffer 310 includes a write pointer and read pointer (not shown) that reference locations in the memory of where one or more layers of information are stored.

Layers of information are stored in each of color buffer 302, depth buffer 304, motion vectors buffer 306, state data buffer 308, and sharpening factor buffer 310. Among other things, the layers of information can be used to upscale a rendered frame of a video game. For example, upscaling techniques can use temporal feedback associated with the difference between two frames to reconstruct high-resolution images while maintaining and even improving image quality compared to native rendering. Various layers of information can be used to provide the temporal feedback. The layers of information can include color data, depth data, motion vector data, state data, and one or more sharpening factors. The layers of information can also include a reactive mask and a transparency and composition mask.

Color buffer 302 stores color data associated with a rendered frame. Color data is a layer of information that can be used as temporal feedback to upscale a rendered video frame. Color data of the rendered frame can be in the red-green-blue (RGB) color space or standard RGB (sRGB) color space data. Color data can contain alpha values for each pixel in the frame. Color data can include a single color per pixel or can logically divide the pixel into subpixels. Dividing the color data by subpixel can enable anti-aliasing techniques such as multi-sampling. Color data can be in the high-dynamic range (HDR). HDR, in the context of imaging, refers to the range of luminosity between the brightest area and the darkest area in an image. In some embodiments, color buffer 302 includes multiple color buffers. For example, color buffer 302 can include a main color buffer associated with the rendered video frame to be displayed on a screen. In another example, color buffer 302 can include other color buffers associated with objects that are not rendered on a screen when the rendered frame is displayed. Color data can be computed and stored by GPU 212.

Depth buffer 304 stores depth data associated with a rendered frame. Depth data represents the depth information of objects in 3D space from a particular perspective. The depth of the object can be stored as a height map of the image where the values represent a distance to the camera perspective of the image, with 0 being closest to the camera. In some embodiments, certain encoding schemes can flip the value representing a distance to the camera perspective of an image such that the highest number is the value closest to the camera. In some embodiments, the image drawn in the frame has an infinitely far plane. Depth data is a layer of information that can be used as temporal feedback to upscale a rendered frame. For example, depth data can aid the upscaling techniques by ensuring that the correct polygons properly occlude other polygons in the frame. Depth data for a frame can be stored in depth buffer 304 as 16-bit floating point values. Depth data can be computed and stored by GPU 212.

Motion vectors buffer 306 stores motion vector data associated with a rendered video frame. Motion vector data represents two-dimensional vectors used for motion estimation of corresponding points of one image to another, such as adjacent frames in a video sequence. Motion vectors can relate to specific parts, such as blocks, patches, or pixels, of a frame. Depending on the rendering technique used, motion vector data can correspond to any technically feasible range. The range of the motion vector data can be scaled to the expected range for the upscaling techniques herein. Motion vector data can be stored as 16-bit floating point values. Motion vector data can be computed and stored by GPU 212.

State data buffer 308 stores state data associated with a rendered frame. State data represents information associated with the state of a video game in the rendered frame. State data can indicate changes in state, such as opening a menu in a user interface, a scene transition, or the start or end of a scene. State data can be used to inform an upscaler that temporal information is not needed anymore, in order to avoid ghosting in an upscaled frame. Ghosting refers to a visual artifact in a video where an object in the video appears to have a trail or is doubled from one frame of the video to the next (e.g., one from one scene to a next frame from another scene). State data can be computed and stored by GPU 212.

Sharpening factor buffer 310 stores sharpening factor data associated with a rendered frame. Sharpening factor data represents the clarity of detail in a rendered frame. Sharpening factor data can be affected by the resolution and acutance of the rendered frame. Higher acutance results in sharp transitions and details with clearly defined borders. For example, sharpening factor data with high acutance can result in halos appearing around the edges of the rendered frame. In some embodiments, sharpening factor data can include a sharpening type. For example, sharpening factor data can represent a set of values representing a configuration of a sharpening type. Sharpening factor data can be computed and stored by GPU 212.

In some embodiments, a reactive mask buffer (not shown) can optionally be included in buffers 220. In such cases, the reactive mask buffer stores reactive mask data associated with a rendered frame. Reactive mask data can be used when the other layers of information associated with a rendered frame is incomplete, such as information missing in the depth buffer or motion vector buffer. For example, reactive mask data can include particles or alpha-blended objects that are not included in the depth data or motion vector data of a rendered frame. Reactive mask data indicates how much influence or reliance the history of rendered frames has over the production of the upscaled frame. For example, reactive mask data can indicate a value from 0.0 to 1.0 that indicates how much influence a pixel should have over the production of the upscaled frame. If a reactive mask is not provided during upscaling, an internally generated 1 by 1 texture with a cleared reactive value can be used instead. Reactive mask data can be computed and stored by GPU 212.

In some embodiments, a transparency and composure mask buffer (not shown) can optionally be included in buffers 220. In such cases, the transparency and composure mask buffer stores transparency and composure mask data associated with a rendered frame. Transparency and composure mask data represents the opacity or transparency of objects and surfaces in a rendered frame. For example, some areas of a rendered frame may not have associated motion vector data matching a change in shading between adjacent frames, such as when a surface in the rendered frame is highly reflective or when an object in the rendered frame has a textured animation. The transparency and composure mask data can be an alternative to the reactive mask data when the influence of the history of frames is less important to the production of the upscaled frame. To compute transparency and composure mask data, GPU 212 requires light information of the rendered frame. Transparency and composure mask data can be computed and stored by GPU 212.

FIG. 4 is a more detailed illustration of a user device 106, according to various embodiments. As described above, a user device 106 can include computer systems, set top boxes, mobile devices, smartphones, tablets, console and handheld video game systems, digital video recorders (DVRs), DVD players, connected digital TVs, dedicated media streaming devices (e.g., the Roku® set-top box), and/or any other technically feasible computing device that has network connectivity and is capable of upscaling and displaying frames of a video game to a user. In operation, user device 106 is configured to communicate with a server 102 via the network 104 to receive graphical data, such as frames of a video game, and upscale the graphical data to a higher resolution for presentation on a display device 422. The display device 422 can be part of user device 102 or distinct from user device 102. As shown, user device 106 includes, without limitation, a processor 404, an input/output interface 406, a network interface 408, an interconnect bus 410, a memory 412, and a GPU 414. Memory 210 includes a client application 416. Client application 416 can include a player 418 and an upscaler 420. As shown, user device 106 connects to a display device 422 via input/output interface 406.

Processor 404 is configured to read and write data from memory 412. Processor 404 is configured to retrieve and execute programming instructions, such as instructions for client application 416, stored in memory 412. Similarly, processor 404 is configured to store video game application data (e.g., software libraries) and retrieve video game application data from memory 412. Processor 404 can be any suitable processor, such as a CPU, an ASIC, a FPGA, a DSP, and/or any other type of processing unit, or a combination of processing units. In general, processor 404 can be any technically feasible hardware unit capable of processing data and/or executing software applications. Interconnect 410 is configured to facilitate transmission of data, such as programming instructions and application data, between processor 404 and network interface 408, memory 412, and GPU 414.

Input/output interface 406 is configured to receive upscaled video data from upscaler 420 and send upscaled video data to display device 422 for display. Input/output interface 406 is configured to receive any number and/or types of inputs via display device 422 and can display any number and/or types of outputs via display device 422.

Network interface 408 is configured to transmit and receive audio content from a network (not shown). In some embodiments, network interface 206 is configured to communicate using an Ethernet Network, a Bluetooth® network, a wireless network, or any other technically feasible network for communicating video game data. Network interface 408 communicates with processor 404, input/output interface 406, memory 412, and GPU 414 via interconnect bus 410.

Interconnect bus 410 is configured to facilitate transmission of data, such as programming instructions, application data, audio and/or video data, and other data, between processor 404, input/output interface 406, network interface 406, memory 412, GPU 414 and any other components of user device 106. Other aspects of user device 106 that are not shown can also communicate with each other aspect of user device 106 using interconnect bus 410.

Memory 412 can include a random-access memory (RAM) module, a flash memory unit, or any other type of memory unit or combination thereof. In various embodiments, memory 412 includes non-volatile memory, such as optical drives, magnetic drives, flash drives, or other storage. In some embodiments, separate data stores, such as an external data store included in a network (“cloud storage”) (not shown) can supplement the memory 412. Client application 416 within memory 414 can be executed by processor 404 to implement the overall functionality of user device 106.

Client application 416 is a software application that is stored in memory 412 of user device 106 and executes on processor 404 of user device 106. Illustratively, client application 416 includes player 418 that is configured to decode audio, video, and text data, as well as play back the same. Client application 416 also includes an upscaler 420 that is configured to upscale rendered frames of a video game from a first resolution to a second resolution that is higher quality than the first resolution. Client application 416 is configured to connect to and communicate with server 102 via network interface 410 to access, consume, and manipulate content or engage in various digital activities, including streaming video games. For example, client application 416 can receive any number or types of input related to playing a video game from a user via display device 422. Client application 416 can communicate with server 102 that is executing the video game associated with the input. Client application 416 can receive encoded frames and encoded layers of information associated with the video game from server 102 via network interface 408. Player 418 of client application 416 can decode the encoded frames and encoded layers of information.

Player 418 includes software and/or hardware designed to decode audio, video, and/or text data, as well as play back the same. Decoding is the process of converting encoded data into raw digital content for transmission and/or display. Player 418 can process various types of content, such as audio, video, and/or text, by applying decompression algorithms and decoding schemes to transform encoded data into raw digital content for display. Player 418 can support multiple decoding standards and codecs to accommodate different content types and delivery platforms. In some embodiments, player 418 can include a YC_{B}C_{R} decoder, where Y represents the luma component of a pixel, C_{B} represents the blue-difference chroma component of a pixel, and C_{R} represents the red-difference chroma component of a pixel. Player 418 can decode YC_{B}C_{R} pixel formats using any technically feasible encoding scheme, such as 4:4:4, 4:1:1, 4:2:2 and/or 4:2:0.

Player 418 is part of client application 416 and is configured to receive encoded frames and encoded layers of information generated by a server, such as server 102. Layers of information are that can be used to upscale a rendered video frame. As described, the layers of information can include color data, depth data, motion vector data, state data, and one or more sharpening factors. The layers of information can also include a reactive mask and a transparency and composition mask. Player 418 can decode each layer of information within the layers of information from a compressed format, such as 10 bits per pixel, to an uncompressed format to be used during upscaling. In some embodiments, player 418 also decodes the received encoded frames from a compressed format, such as a compressed video file, to a raw digital video ready to be upscaled. The decoded frames and decoded layers of information can be used by upscaler 420 to create an upscaled frame.

Upscaler 420 is a module that is part of client application 416. Upscaler 420 is configured to upscale frames of a video game based on layers of information associated with the frames. The frames and layers of information can be decoded by decoder 416 prior to being received by upscaler 420. Upscaler 420 can be used in combination with GPU 414 to perform the upscaling of frames. For example, upscaler 420 can use the logic and computing power of GPU 414 to perform the upscaling process. Upscaling is the process of increasing the size of an image while maintaining or improving the clarity and detail, such as increasing the resolution of a rendered frame from a 1920×1080 pixel resolution to a 4096×2160 pixel resolution. The upscaling process analyzes the layers of information associated with a frame in the first resolution (e.g., 1920×1080 pixels) and extrapolates how the frame should appear in the second resolution (e.g., 4096×2160 pixels). In the example of upscaling from a 1920×1080 pixel resolution to a 4096×2160 pixel resolution, each pixel in the 1920×1080 pixel resolution represents four pixels in the 4096×2160 pixel resolution. The simple process of stretching one pixel to account for four pixels results in a blurry image. Therefore, in order to make sure the final image in the second resolution is not blurry, upscaler 420 uses the layers of information to determine the correct color, depth, motion vector, and other important characteristics of the new pixels. Upscaler 420 can perform any technically feasible upscaling in some embodiments. For example, in some embodiments, upscaler 420 can perform a temporal upscaling technique, such as FidelityFX Super Resolution (FSR), Deep Learning Super Sampling (DLSS), or the like. In some embodiments, the upscaling technique can utilize a trained neural network, and server 102 can also transmit the trained neural network to user device 106 via, e.g., a data stream. In some embodiments, the upscaling technique can utilize any amount of hardware support provided by GPU 414.

GPU 414 is a graphics processing unit that is a specialized electronic circuit configured to perform mathematical calculations at high speed to process graphics and video. In some embodiments, GPU 414 can be integrated into an integrated circuit, along with processor 404. In some embodiments, GPU 414 can be a discrete graphics processing unit or dedicated graphics processing unit, that is separate from processor 404. In some embodiments, GPU 414 includes multiple graphics processing units working in tandem. GPU 414 is configured to perform the same operation on multiple data values simultaneously (e.g., parallel processing).

In some embodiments, GPU 414 can be used in GPU accelerated decoding where portions of the decoding process and post-processing are offloaded to GPU 414. In some embodiments, GPU 414 is configured to use layers of information, received from server 102 via network interface 408, to upscale frames of a video game, decoded by player 418, in combination with upscaler 420. In some embodiments, GPU 414 is configured to receive assets (e.g., textures) and GPU command buffer information for rendering a user interface from server 102 via network interface 408. The user interface can be a 2D interface for a video game. GPU 414 is configured to finish rendering the user interface in any technically feasible way using the assets and the command buffer information. GPU 414 is configured to render the user interface in the native resolution of user device 106. Once the final rendering is completed, the fully rendered user interface is transmitted, for display, to display device 422 via input/output interface 406.

Display device 422 can be any device that is capable of displaying an image and/or any other type of visual content. For example, display device 422 could be, without limitation, a liquid crystal display, a light-emitting diode display, a projection display, a plasma display panel, etc. In some embodiments, the display device 422 is a touchscreen that is capable of displaying visual content and receiving input (e.g., from a user). Display device 422 can be part of user device 106 or display device 422 can be a separate device.

### Client-Side Upscaling of Video Games

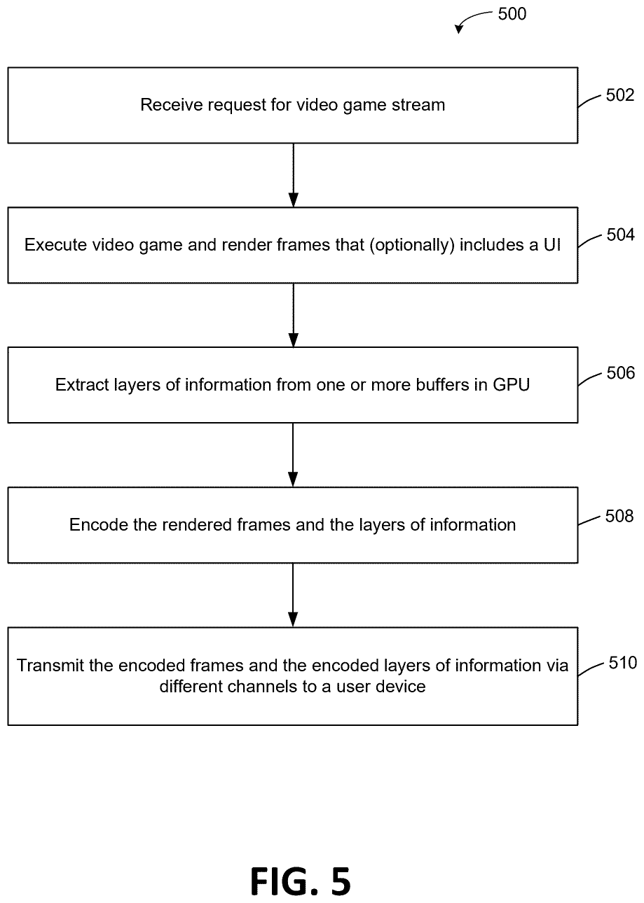

FIG. 5 is a flow diagram of method steps for streaming video games to a user device, according to various embodiments. Although the method steps are described in conjunction with the systems of FIG. 1-4, persons skilled in the art will understand that any system configured to perform the method steps in any order falls within the scope of the various embodiments.

As shown, a method 500 begins at step 502, where server 102 receives a request for a video game to be streamed to user device 106. In some embodiments, server 102 and user device 106 can also perform a handshake, during which server 102 can determine the capabilities of user device 106, including whether user device 106 is capable of performing upscaling of frames of the video game that are streamed to user device 106. Steps 504-510 assume user device 106 is capable of performing upscaling. In addition, server 102 can determine the requested video game from a library of video games stored in a data store. Server 102 is a computing device that can execute program instructions for the requested video game, render frames of the video game, and deliver the rendered frames, as well as layers of information needed to upscale the frames to a higher resolution, to user device 106 via network 104. User device 106 can be a computer system, set top box, mobile device, smartphone, tablet, console or handheld video game system, DVR, DVD player, connected digital TV, dedicated media streaming device (e.g., the Roku® set-top box), and/or any other technically feasible computing device that has network connectivity and is capable of upscaling and displaying frames of the video game to a user.

At step 504, server 102 executes the program instructions of the video game requested by user device 106. Server 102 can execute the program instructions by using, in parallel, the processor of server 102 for general operations of the video game and using the GPU of server 102 for graphic specific operations of the video game, such as graphics rendering, texture mapping, shader processing, and frame-rate management. For example, GPU 212 of server 102 could generate frames of a video game and renders the 2D and/or 3D graphics within the frames in combination with game engine 214 of server 102. Additionally, server 102 includes a game engine to facilitate execution of the video game and rendering the graphics of the video game. For example, game engine 214 of server 102 includes a rendering engine that communicates with GPU 212 to render 2D and/or 3D graphics of video games. Game engine 214 can also include a physics engine, a collision detection engine, a sound engine, an artificial intelligence model, one or more software libraries, and/or a memory management module to facilitate execution of video games and/or rendering of the frames of video games.

In some embodiments, GPU 212 is configured to start rendering a 2D user interface associated with a video game. Prior to completing the render of the user interface, the GPU 212 can be instructed to stop rendering the user interface, such that a GPU on a user device can finish rendering the user interface in the native resolution of the user device. In such cases, assets (e.g., textures) and GPU command buffer information for rendering the user interface can be transmitted to a user device via network interface 206 in a similar manner as frames of the video game and/or layers of information. In some embodiments, the transmission of the assets and command buffer information for the user interface can be via a separate channel of a data stream.

At step 506, server 102 extracts layers of information from one or more buffers in GPU 212. For example, each buffer in buffers 220 in GPU 212 can be a first-in first-out (FIFO) buffer. A buffer 220 can be implemented, without limitation, as a single buffer, double buffer, circular buffer, array buffer, ring buffer, vertex buffer, constant buffer, or any other technically feasible type of buffer. As described above, layers of information are stored in buffers 220 of GPU 212 and can be used to upscale a rendered frame of a video game. In some embodiments, the layers of information can include color data, depth data, motion vector data, state data, and one or more sharpening factors. In some embodiments, the layers of information can also include a reactive mask and a transparency and composition mask. Upscaling is the process of increasing the size of an image while maintaining or improving the clarity and detail. The simple upscaling process of stretching one pixel to account for multiple pixels can result in a blurry image. Therefore, in order to do make sure the final image is not blurry, the layers of information extracted from buffers 220 can be used to determine the correct color, depth, motion vector, and other important characteristics of the new pixels.

At step 508, server 102 encodes the rendered frames and encodes the extracted layers of information via encoder 216. Encoder 216 is configured to receive rendered frames and layers of information from GPU 212. As described, the layers of information are stored in buffers 220 of GPU 212 and can be used to upscale a rendered frame. In some embodiments, encoder 216 can encode one or more layers of information within the layers of information using, for example, 10 bits per pixel. In such cases, encoder 216 can scale down, for example, 32-bit floating-point values to 10 bits using a lossless compression technique, and the reverse process can be performed during decoding. For example, depth values can be encoded as 10-bit integer values representing the luminance values of pixels; the x and y components of motion vectors can be similarly encoded as red and green values, respectively, of the pixels, etc., thereby “hiding” the buffer 220 data in channels of video data. Although described herein with respect to 10 bits as a reference example, any suitable format can be used to encode the layers of information within pixels of video data and/or a data stream can be used in some embodiments. In some embodiments, encoder 216 also encodes the rendered frames into a moving picture experts group 4 part 14 (MPEG-4 Part 14 or MP4) file format.

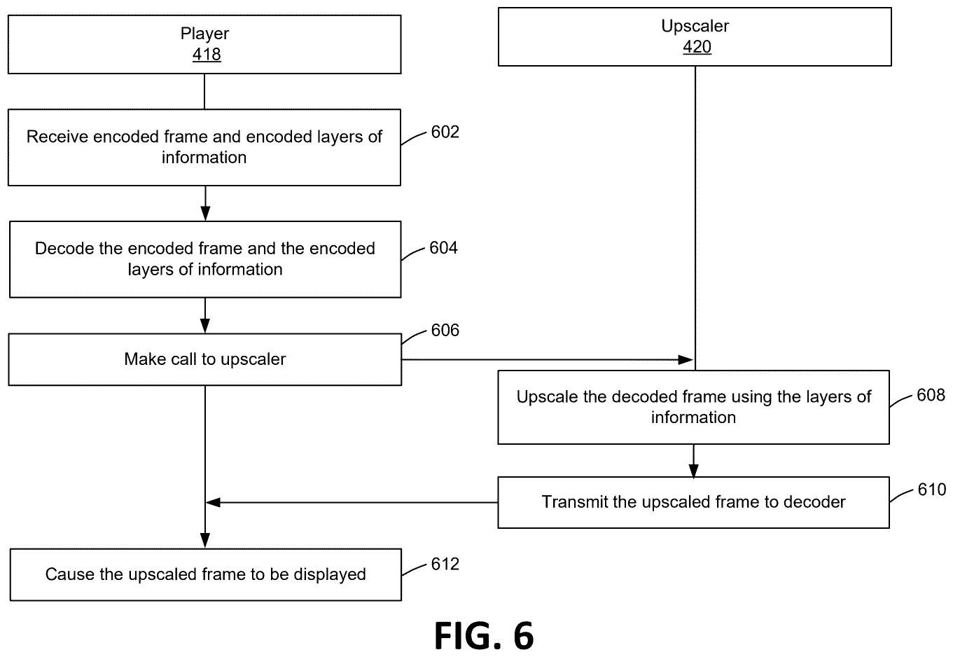

At step 510, server 102 transmits the encoded frames and layers of information to a user device 106. The transmission of the encoded frames and layers of information can be via multiple channels of a video stream (e.g., a H.264 stream or an AVI stream) and/or data stream (e.g., a webRTC stream). Each layer of information can be transmitted via a different channel. In some embodiments, assets (e.g., textures) and GPU command buffer information for rendering a user interface can also be transmitted to a user device 106, such as via a different channel of a data stream. User device 106 receives the encoded frames and layers of information, and optionally receives the assets and command buffer information for the user interface. User device 106 decodes the encoded frames and layers of information and uses the decoded layers of information to upscale the decoded frames to a higher resolution than the resolution the frames were rendered at, as discussed in greater detail below in conjunction with FIG. 6. In addition, user device 106 can use the assets and command buffer information for the user interface to render the user interface at a native resolution of the user device 106.

FIG. 6 is a flow diagram of method steps for client-side upscaling of streamed video games, according to various embodiments. Although the method steps are described in conjunction with the systems of FIG. 1-4, persons skilled in the art will understand that any system configured to perform the method steps in any order falls within the scope of the various embodiments.

As shown, a method 600 begins at step 602, where player 418, which is part of client application 416 executing in user device 106, receives an encoded frame and encoded layers of information associated with the encoded frame. Although FIG. 6 is described with respect to a single encoded frame, steps 602-612 of method 600 can be repeated for multiple encoded frames. The encoded frame received at step 602 is a rendered frame of a video game running on a server 102 that was encoded by an encoder 216 and streamed to user device 106. The encoded layers of information are layers of information extracted from GPU 212 of server 102, encoded by encoder 216, and streamed to user device 106. In some embodiments, the encoded frame and encoded layers of information can be streamed to user device 106 via different channels in of a video stream and/or data stream, as described above in conjunction with FIG. 5.

At step 604, player 418 decodes the encoded frame and encoded layers of information. As described, the layers of information can be used to upscale a frame of a video game. In some embodiments, the layers of information can include color data, depth data, motion vector data, state data, and one or more sharpening factors. In some embodiments, the layers of information can also include a reactive mask and a transparency and composition mask. Player 418 decodes the encoded frame from an encoded format, such as a compressed video file, to raw digital video that can be upscaled. Player 418 also decodes each layer of information within the layers of information from a compressed format, such as 10 bits per pixel, to an uncompressed format for use in the upscaling.

At step 606, player 418 makes a call to upscaler 420 to upscale the decoded frame using the decoded layers of information. Upscaler 410 is a module that is part of client application 416. Upscaler 420 is configured to upscale frames of a video game based on layers of information associated with the frames. The frames and layers of information can be decoded by decoder 416 prior to being received by upscaler 420.

At step 608, upscaler 420, in combination with GPU 414 of user device 106, upscales the decoded frame using the decoded layers of information. For example, upscaler 420 could use the logic and computing power of GPU 414 to perform the upscaling process. As described, upscaling is the process of increasing the size of an image while maintaining or improving the clarity and detail, such as increasing the resolution of a rendered video frame from a 1920×1080 pixel resolution to a 4096×2160 pixel resolution. The simple process of stretching one pixel to account for multiple pixels can result in a blurry image, so upscaler 420 uses the layers of information to determine the correct color, depth, motion vector, and other important characteristics of the new pixels. Upscaler 420 can perform any technically feasible upscaling in some embodiments. For example, in some embodiments, upscaler 420 can perform a temporal upscaling technique such as FSR, DLSS, or the like. In some embodiments, the upscaling technique can utilize a trained neural network, and server 102 can also transmit the trained neural network to user device 106 via, e.g., a data stream. In some embodiments, the upscaling technique can utilize any amount of hardware support provided by GPU 414.

At step 610, upscaler 420 transmits the upscaled frame back to player 418. Then, at step 612, player 418 causes the upscaled frame to be displayed. That is, rather than displaying the decoded frame from step 604 that is at a lower resolution, player 418 causes the upscaled frame to be displayed. In some embodiments, player 418 can also synchronize the display of the upscaled frame with corresponding audio that can also be decoded. For example, player 418 can transmit the upscaled frames to display device 422 associated with user device 106 (and corresponding audio to an audio output device), to display the upscaled frames (and output the audio) to a user playing the video game associated with the upscaled frame. Player 418 can transmit the upscaled frame to display device 422 via input/output interface 406. As described, display device 422 can be any device that is capable of displaying an image and/or any other type of visual content. For example, display device 422 could be, without limitation, a liquid crystal display, a light-emitting diode display, a projection display, a plasma display panel, etc. In some embodiments, display device 422 is a touchscreen that is capable of displaying visual content and receiving input (e.g., from a user).

In sum, the disclosed techniques allow for client-side upscaling of streamed video games. As used herein, a video game refers to any application that provides an interactive 3D space, such as an electronic game, a metaverse, or the like. In some embodiments, a server executes a video game and renders frames thereof using a GPU of the server. The frames are rendered at a low resolution (e.g., below 1080p). The server extracts layers of information needed to upscale the rendered frames from one or more buffers in the GPU of the server. The layers of information can include color data, depth data, motion vector data, state data, and one or more sharpening factors. The layers of information can also include a reactive mask and a transparency and composition mask. The server encodes the rendered frames and the layers of information. The server streams, over a network, the encoded frame data and the encoded layers of information to a user device. A separate channel can be used to stream each of the encoded frame data and each layer of information in the encoded layers of information. Once received by the user device, the user device can decode and upscale the frame using the layers of information, and then display the upscaled frame. The upscaled frame is of a higher resolution than the rendered frame. In some embodiments, another layer that includes data associated with a user interface can also be streamed via another channel to the user device, after which the user device can use the streamed layer of data to render the user interface at a native resolution of the user device.

At least one technical advantage of the disclosed techniques relative to the prior art is that, with the disclosed techniques, the upscaling of the rendered frames of a video game is performed on a user device rather than a server device. By utilizing a GPU of the user device to perform the upscaling, computational resources of the server device and network bandwidth can be conserved. In turn, the server device can be used to execute and stream video games to a larger number of user devices. These technical advantages provide one or more technological improvements over prior art approaches.
1. In some embodiments, a computer-implemented method for client-side upscaling of video games comprises rendering, via a graphics processing unit (GPU) and at a first resolution, a frame associated with a video game; extracting one or more layers of information from one or more buffers of the GPU; encoding the frame to generate an encoded frame and the one or more layers of information to generate one or more encoded layers of information; and transmitting, to a user device, the encoded frame and the one or more encoded layers of information, wherein the user device upscales a decoding of the encoded frame to a second resolution based on a decoding of the one or more encoded layers of information.
2. The computer-implemented method of clause 1, wherein the layers of information include at least one of color data associated with the frame, depth data associated with the frame, motion vector data associated with the frame, state data associated with the frame, sharpening factor data associated with the frame, reactive mask data associated with the frame, or transparency and composure mask data associated with the frame.
3. The computer-implemented method of any of clauses 1-2, wherein each of the one or more layers of information is encoded using ten bits per pixel.
4. The computer-implemented method of any of clauses 1-3, further comprising transmitting a trained neural network to the user device, wherein the user device further upscales the decoding of the encoded frame based on the trained neural network.
5. The computer-implemented method of any of clauses 1-4, wherein the one or more layers of information include temporal data.
6. The computer-implemented method of any of clauses 1-5, wherein the user device further displays the decoding of the encoded frame that has been upscaled to the second resolution.
7. The computer-implemented method of any of clauses 1-6, further comprising: generating, via the GPU, one or more assets and one or more commands for rendering a user interface (UI) associated with the video; and transmitting, to the user device, the one or more assets and the one or more commands, wherein the user device renders the UI in a native resolution associated with the user device based on the one or more assets and the one or more commands.
8. The computer-implemented method of any of clauses 1-7, wherein the encoded frame and the one or more encoded layers of information are transmitted to the user device via separate data channels of at least one of a video stream or a data stream.
9. The computer-implemented method of any of clauses 1-9, further comprising: rendering, via the GPU and at a third resolution, a second frame associated with the video game; extracting one or more second layers of information from the one or more buffers of the GPU; encoding the second frame to generate an encoded second frame and the one or more second layers of information to generate one or more encoded second layers of information; and transmitting, to the user device, the encoded second frame and the one or more encoded second layers of information, wherein the user device upscales a decoding of the encoded second frame to the second resolution based on a decoding of the one or more encoded second layers of information.
10.The computer-implemented method of any of clauses 1-9, further comprising executing the video game based on one or more inputs received from the user device.
11.In some embodiments, one or more non-transitory computer-readable media including instructions that, when executed by one or more processors, cause the one or more processors to perform the steps of: rendering, via a graphics processing unit (GPU) and at a first resolution, a frame associated with a video game; extracting one or more layers of information from one or more buffers of the GPU; encoding the frame to generate an encoded frame and the one or more layers of information to generate one or more encoded layers of information; and transmitting, to a user device, the encoded frame and the one or more encoded layers of information, wherein the user device upscales a decoding of the encoded frame to a second resolution based on a decoding of the one or more encoded layers of information.
12.The one or more non-transitory computer-readable media of clause 11, wherein the instructions, when executed by one or more processors, further cause the one or more processors to perform the step of executing the video game based on one or more inputs received from the user device.
13.The one or more non-transitory computer-readable media of any of clauses 11-12, wherein the instructions, when executed by one or more processors, further cause the one or more processors to perform the step of: generating, via the GPU, one or more assets and one or more commands for rendering a UI associated with the video; and transmitting, to the user device, the one or more assets and the one or more commands, wherein the user device renders the US in a native resolution associated with the user device based on the one or more assets and the one or more commands.
14.The one or more non-transitory computer-readable media of any of clauses 11-13, wherein the user device further displays the decoding of the encoded frame that has been upscaled to the second resolution.
15.The one or more non-transitory computer-readable media of any of clauses 11-14, wherein each of the one or more layers of information is encoded using ten bits per pixel.
16.The one or more non-transitory computer-readable media of any of clauses 11-15, wherein the one or more layers of information include at least one of color data associated with the frame, depth data associated with the frame, motion vector data associated with the frame, state data associated with the frame, sharpening factor data associated with the frame, reactive mask data associated with the frame, or transparency and composure mask data associated with the frame.
17.The one or more non-transitory computer-readable media of any of clauses 11-18, wherein the one or more layers of information includes temporal feedback data associated with the frame.
18.The one or more non-transitory computer-readable media of any of clauses 11-17, wherein encoding the one or more layers of information comprises converting 32-bit floating-point values to ten-bit values.
19.The one or more non-transitory computer-readable media of any of clauses 11-18, wherein encoding the frame comprises converting a format of the frame to a moving picture experts group 4 part 14 (MPEG-4 Part 14 or MP4) file format.
20. In some embodiments, a system comprises one or more memories storing instructions; and one or more processors coupled to the one or more memories that, when executing the instructions, perform the steps of: rendering, via a graphics processing unit (GPU) and at a first resolution, a frame associated with a video game; extracting one or more layers of information from one or more buffers of the GPU; encoding the frame to generate an encoded frame and the one or more layers of information to generate one or more encoded layers of information; and transmitting, to a user device, the encoded frame and the one or more encoded layers of information, wherein the user device upscales a decoding of the encoded frame to a second resolution based on a decoding of the one or more encoded layers of information.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for client-side upscaling of video games, the method comprising:
rendering, via a graphics processing unit (GPU) and at a first resolution, a frame associated with a video game;
extracting one or more layers of information from one or more buffers of the GPU;
encoding the frame to generate an encoded frame and the one or more layers of information to generate one or more encoded layers of information; and
transmitting, to a user device, the encoded frame and the one or more encoded layers of information, wherein the user device upscales a decoding of the encoded frame to a second resolution based on a decoding of the one or more encoded layers of information.

2. The computer-implemented method of claim 1, wherein the layers of information include at least one of color data associated with the frame, depth data associated with the frame, motion vector data associated with the frame, state data associated with the frame, sharpening factor data associated with the frame, reactive mask data associated with the frame, or transparency and composure mask data associated with the frame.

3. The computer-implemented method of claim 1, wherein each of the one or more layers of information is encoded using ten bits per pixel.

4. The computer-implemented method of claim 1, further comprising transmitting a trained neural network to the user device, wherein the user device further upscales the decoding of the encoded frame based on the trained neural network.

5. The computer-implemented method of claim 1, wherein the one or more layers of information include temporal data.

6. The computer-implemented method of claim 1, wherein the user device further displays the decoding of the encoded frame that has been upscaled to the second resolution.

7. The computer-implemented method of claim 1, further comprising:
generating, via the GPU, one or more assets and one or more commands for rendering a user interface (UI) associated with the video; and
transmitting, to the user device, the one or more assets and the one or more commands, wherein the user device renders the UI in a native resolution associated with the user device based on the one or more assets and the one or more commands.

8. The computer-implemented method of claim 1, wherein the encoded frame and the one or more encoded layers of information are transmitted to the user device via separate data channels of at least one of a video stream or a data stream.

9. The computer-implemented method of claim 1, further comprising:
rendering, via the GPU and at a third resolution, a second frame associated with the video game;
extracting one or more second layers of information from the one or more buffers of the GPU;
encoding the second frame to generate an encoded second frame and the one or more second layers of information to generate one or more encoded second layers of information; and
transmitting, to the user device, the encoded second frame and the one or more encoded second layers of information, wherein the user device upscales a decoding of the encoded second frame to the second resolution based on a decoding of the one or more encoded second layers of information.

10. The computer-implemented method of claim 1, further comprising executing the video game based on one or more inputs received from the user device.

11. One or more non-transitory computer-readable media including instructions that, when executed by one or more processors, cause the one or more processors to perform the steps of:
rendering, via a graphics processing unit (GPU) and at a first resolution, a frame associated with a video game;
extracting one or more layers of information from one or more buffers of the GPU;
encoding the frame to generate an encoded frame and the one or more layers of information to generate one or more encoded layers of information; and
transmitting, to a user device, the encoded frame and the one or more encoded layers of information, wherein the user device upscales a decoding of the encoded frame to a second resolution based on a decoding of the one or more encoded layers of information.

12. The one or more non-transitory computer-readable media of claim 11, wherein the instructions, when executed by one or more processors, further cause the one or more processors to perform the step of executing the video game based on one or more inputs received from the user device.

13. The one or more non-transitory computer-readable media of claim 11, wherein the instructions, when executed by one or more processors, further cause the one or more processors to perform the step of:
generating, via the GPU, one or more assets and one or more commands for rendering a UI associated with the video; and
transmitting, to the user device, the one or more assets and the one or more commands, wherein the user device renders the US in a native resolution associated with the user device based on the one or more assets and the one or more commands.

14. The one or more non-transitory computer-readable media of claim 11, wherein the user device further displays the decoding of the encoded frame that has been upscaled to the second resolution.

15. The one or more non-transitory computer-readable media of claim 11, wherein each of the one or more layers of information is encoded using ten bits per pixel.

16. The one or more non-transitory computer-readable media of claim 11, wherein the one or more layers of information include at least one of color data associated with the frame, depth data associated with the frame, motion vector data associated with the frame, state data associated with the frame, sharpening factor data associated with the frame, reactive mask data associated with the frame, or transparency and composure mask data associated with the frame.

17. The one or more non-transitory computer-readable media of claim 11, wherein the one or more layers of information includes temporal feedback data associated with the frame.

18. The one or more non-transitory computer-readable media of claim 11, wherein encoding the one or more layers of information comprises converting 32-bit floating-point values to ten-bit values.

19. The one or more non-transitory computer-readable media of claim 11, wherein encoding the frame comprises converting a format of the frame to a moving picture experts group 4 part 14 (MPEG-4 Part 14 or MP4) file format.

20. A system comprising:
one or more memories storing instructions; and
one or more processors coupled to the one or more memories that, when executing the instructions, perform the steps of:
rendering, via a graphics processing unit (GPU) and at a first resolution, a frame associated with a video game;
extracting one or more layers of information from one or more buffers of the GPU;
encoding the frame to generate an encoded frame and the one or more layers of information to generate one or more encoded layers of information; and
transmitting, to a user device, the encoded frame and the one or more encoded layers of information, wherein the user device upscales a decoding of the encoded frame to a second resolution based on a decoding of the one or more encoded layers of information.
